(19) United States
(12) Patent Application Publication
(10) Pub. No.: US 2003/0073531 A1
(43) Pub. Date: Apr. 17, 2003

(54) Combination of sprocket set and rivet structure

(75) Inventor: Rock Tseng, Hsinchu (TW)

Correspondence Address: DOUGHERTY & TROXELL, SUITE 1404, 5205 LEESBURG PIKE, FALLS CHURCH, VA, 22041, US

(73) Assignee: Apex Bicycle Components Corporation Ltd.

(21) Appl. No.: 09/976,070

(22) Filed: Oct. 15, 2001

(51) Int. Cl. F16H 55/12; F16H 55/30

(52) U.S. Cl. 474/160; D08/386

(57) ABSTRACT

In a combination structure of sprocket set and rivet, the rivet includes a head part and a drum bolt part. Two sprockets are connected and secured into one body by arranging the bolt part into a penetration-through hole between adjacent sprockets and by applying methods of stamping and riveting on the bolt part. The head part of the rivet is also arranged with a recessed internal hexagonal hole seat to make its outline resemble as an internal hexagonal screw. On the outline, by comparison with a prior rivet that only has a monotonous flat head part, the internal hexagonal hole seat of the head part of the rivet of the present invention not only further has a sense of beauty and a feeling of high added-value, but also it can have an auxiliary positioning function during the processes of stamping and riveting to make the processes of stamping and riveting be more solid and its connection strength more strong. Additionally, relative to the traditional structure for locking and securing sprockets with screws, the connection of sprocket set of present invention with rivet similar to internal hexagonal screw has the convenience in manufacturing procedure and the cheapness in cost.

### 1. FIELD OF THE INVENTION

The present invention is to provide a combination structure of sprocket set and rivet, especially to an improved structure of large sprocket set and rivet in bicycle.

### 2. BACKGROUND OF THE INVENTION

Accordingly, the large sprocket set of a bicycle in current prevalent usage commonly is connected and secured to one body by applying the means of screw or rivet. In the traditional methods of applying screw (is internal hexagonal screw as usual) for assembling the sprocket, since the screw needs toothing, so manufacturing cost is higher, and it is needed to match with the usage of nut. Not only the number of elements is more and the assembly takes labor and time, but also the costs on both manufacture and assembly for the sprockets are higher, so they are usually applied to the high-class bicycles with high single price and are not prevalent to the sprocket set of bicycles with medium price.

Currently, the bicycle sprocket set of medium and low price are all adopted with rivets to rivet themselves between two sprockets with the manufacturing procedure of stamping for providing an assembling manner of quickness and cheapness. However, one shortcoming for this kind of prior rivet structure is that the configuration of the head part of the rivet is only a shape of flat smooth surface that is very monotonous, and consumer at a glance then may find that it is riveted and assembled with rivets, so it easily gives the consumer the feelings of cheapness, low quality, and ugliness. Therefore, for the bicycle sprocket set assembled by rivet, no matter how we improve the materials application, accuracy control, function design, or even structure strength for the sprockets, it still can not be avoided that the monotonous flat head part configuration for the prior rivet is used, so not only the market price can not be raised, but also the recognition by the consumers who are intended to adopt high quality product are further in difficulties to be obtained, so it is caused while the product with high quality is unable to get into market, and only the low price competition is undergone, furthermore, it hinders the willing of the bicycle manufacturers to engage research and development and improvement in their products.

Additionally, there is one further big shortcoming for prior rivet structure. People know that an appropriate tolerance (clearance) is existed between rivet and rivet-connection hole on two sprockets for accommodating the rivet. However, since the head part for prior rivet shows a flat (thin thickness) smooth surface, and relatively the positioning device for stamping and riveting is also only a shallow round recessed trough for providing the accommodation of the head part of the rivet, and there is no other auxiliary positioning mechanism existed, so the positioning and securing operations for the stamping and rivet-connection device are not very reliable. In the procedures of stamping and rivet-connection, a swinging and moving phenomenon is easily occurred because of a clearance existed between the rivet and the rivet-connection hole. And, in the condition of lacking other auxiliary positioning structure, an abnormal rivet connection is occurred (e.g. inclined rivet) to lower down the structure strength of connection, or even a failure of rivet connection is happened to cause the product being in a state of abolishment. This shortcoming is needed for further improvement.

### SUMMARY OF THE INVENTION

Therefore, the object of the present invention is to provide a combination structure of sprocket set and rivet, which not only has both high added-value and beautiful feeling for sprocket set assembled with traditional screw structure, but also further has the convenience in manufacturing procedure and the superiority in low cost for the sprocket set assembled with rivet. And, a combination structure of sprocket set and rivet further has additionally auxiliary positioning structure to make the rivet connection procedure be further accurate and reliable.

To reach the aforementioned objects, in a preferable embodiment of the present invention, the head part of the rivet has an internal recessed holeseat to make its outline resemble as an internal hexagonal screw. On the outline, by comparing with a traditional rivet that only has a monotonous flat head part, the head part of the rivet of the present invention not only has the sense of beauty and feeling of high added-value, but also it can easily obtain the recognition from consumers. And, relating to the traditional structure for locking and securing sprockets with screws, the connection of sprocket set of present invention with rivet similar to internal hexagonal screw has the convenience in manufacturing procedure and the cheapness in cost. Additionally, for the seat in the procedures of stamping and rivet-connection, a hexagonal convex-column designed on the positioning device may just be inserted into the internal recessed hole seat and further acted as an auxiliary position structure with accuracy, stability, and reliability in the procedures of stamping and rivet connection, and completely overcomes all kinds of shortcoming in prior technique.

### BRIEF DESCRIPTION OF THE DRAWINGS

FIG. 1 is a top view for the preferable embodiment for the rivet connected onto the sprocket set of the present invention.

FIG. 2 is a cross-sectional view (“9-9” section surface) for the embodiment shown in FIG. 1.

FIG. 3 is a side view for a preferable embodiment of the rivet of the present invention.

FIG. 4 is a cross-sectional view for a preferable embodiment of the rivet of the present invention.

FIG. 5 is a cross-sectional view for the second preferable embodiment of the rivet of the present invention.

FIG. 6 is a cross-sectional view for the third preferable embodiment of the rivet of the present invention.

FIG. 7 is a cross-sectional view for the fourth preferable embodiment of the rivet of the present invention.

### DETAILED DESCRIPTION OF THE PREFERRED EMBODIMENT

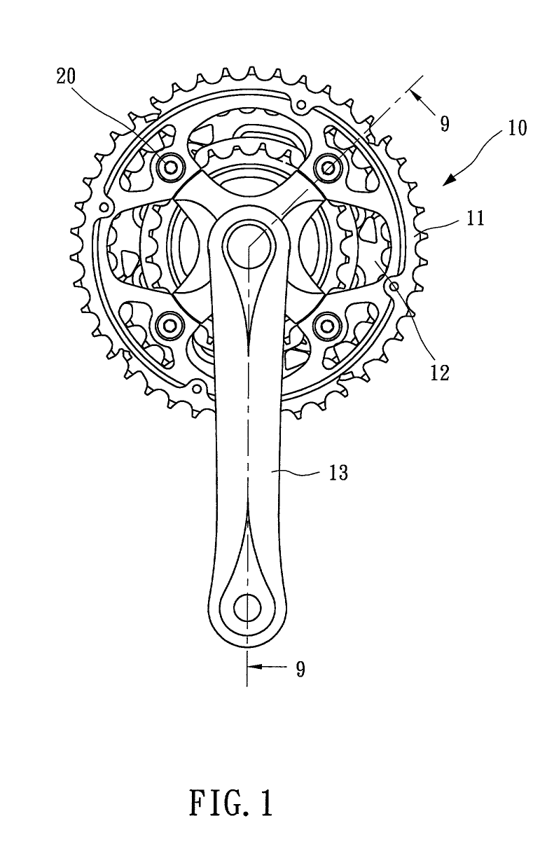

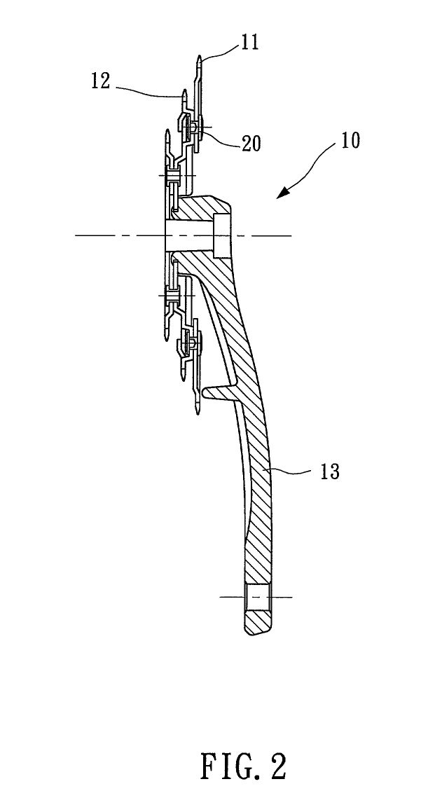

First, please refer to FIG. 1 to FIG. 3, which are the preferable embodiments for the combination structure of sprocket set and rivet of the present invention and applied to a large sprocket set of bicycle. In the present preferable embodiment, the bicycle's large sprocket set 10 is comprised of at least two sprockets 11, 12 and is driven by a mechanism of a crank 13 connecting to two sprockets 11 and 12 for rotation. Several penetration-hole 14 are arranged on the corresponding positions of the two adjacent sprockets 11, 12.

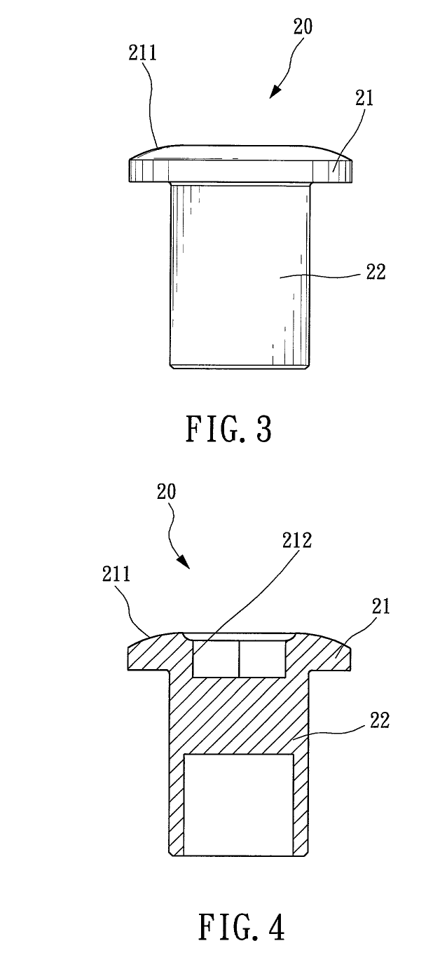

Please refer to FIG. 3 and FIG. 4, wherein FIG. 3 shows a side view for a preferable embodiment of the rivet 20 of the present invention, and FIG. 4 then is a cross-sectional view for the rivet 20. The rivet 20 includes a head part 21, which has a larger outer diameter, and a drum bolt part 22, which has a smaller outer diameter. The two sprockets 11, 12 are connected and secured to one body, by accommodating the bolt part 22 of the rivet 20 into the penetration-through hole 13 between two sprockets 11, 12 and then stamping and rivet-connecting them. The upper surface of the head part 21 of the rivet 20 is a convex arc curing surface 211, and an internal hexagonal hole seat 212 with a recession is also arranged in the head part 21 of the rivet 20. Therefore, the configuration of the head part 21 of the rivet 20 is resembled as an outline of an internal hexagonal screw. On the outline, by comparison with the prior rivet having monotonous flat head part, the designed shape similar to a hexagonal screw of the rivet 20 for the present invention may further have the sense of beauty and feeling of high added-value and easily obtains the recognition from the consumers who pursuit the feeling of high quality. And, relative to the structure of sprocket locked and secured by the traditional screw, the sprocket 10 connected by the rivet 20 of the present invention may have the convenience in manufacturing procedure and the cheapness in cost and completely improve the shortcomings of the prior technique and sufficiently achieve the objects of the present invention.

The specially worth attention is that the structures of internal hexagonal hole seat 212 and the convex arc curving surface 211 designed on the head part 21 of the rivet 20 of the present invention except may increase the sense of beauty and feeling of value, further have the function of auxiliary position during the procedures of stamping and rivet-connection. First, in the procedures of stamping and rivet-connection, the shape of the corresponding position device (not shown in the drawings) for the head part 21 of the rivet 20 is designed as a corresponding recessed arc curving surface for accommodating the convex arc curing surface 211 of the head part 21. And, in the center of the recessed arc curing surface of the positioning device is arranged with a protrusion of hexagonal convex column (not shown in the drawings), of which shape and size are just corresponding to the configuration of the internal hexagonal hole seat 212. By this manner, the rivet 20 of the present invention then may be accurately and firmly secured and positioned on the device. Not only it won't happen the phenomenon of position being biased or inclined during the procedures of stamping and rivet-connection, but also the procedures of stamping and rivet-connection are more accurate, stable and reliable to solidify the strength of rivet-connection structure and further almost exempt the occurrence of failure situation of rivet-connection and completely improve the shortcomings of strength weakening and rivet-connection failure caused by the inclination of the rivet which is easily happened during the rivet-connection of the plat head rivet in the prior technique.

In fact, since the processing and manufacturing techniques in today are progressed, so even the rivet-connection technique of the rivet is applied, a bicycle's sprocket set with high quality may also be manufactured out. However, because the monotonous impression on the sprocket set assembled by rivet-connection is already implanted in the minds of ordinary consumers, so no matter how the current manufacturers of the bicycle's sprockets make all their efforts on upper-and-lower chains structure's designs, process accuracy, heat treatment, and metal materials selection for the sprockets, or improve the other parts for increasing the functions and usage endurance for the product of the sprocket set itself in any how, as soon as the consumers at a glance find out the sprocket set being assembled by the rivet, the consumers then consider the products to be cheap and of low quality and are unwilling to purchase them with higher price. Therefore, not only the product of higher quality can not be cut into the market because of higher manufacturing cost, but also it further causes that the manufacturers of the bicycle sprockets would rather lower down the price for competition than engage in the improvement and R & D for the product, so it becomes a hindrance for the progress of the industry. In the present invention, the structure of the connection rivet on the sprockets set is improved, so the consumers won't easily reject to accept the product of sprockets assembled by rivet because of their monotonous impression on rivet. As soon as the consumers can accept the new idea that even the sprocket set assembled by rivet still can have high quality and feelings of high added-value, then all the manufacturers of bicycle's sprockets could give up the competition manner of lower price dumping strategy and may promote their products' competition ability by the methods of increasing the added-value and functional improvement of the product and further are willing to devote investment into the R & D jobs. Therefore, it is believed that there will be absolutely positive results for good circulation for national industry technology as well as international competition ability. Furthermore, the structures of internal hexagonal hole seat 212 and the convex arc curving surface 211 designed on the head part 21 of the rivet 20 of the present invention further have the function of auxiliary position during the procedures of stamping and rivet-connection. Then, the rivet 20 of the present invention may be accurately and firmly secured and positioned on the device. Not only it won't happen the phenomenon of position being biased or inclined during the procedures of stamping and rivet-connection, but also the procedures of stamp and rivet-connection are more accurate, stable and reliable to solidify the strength of rivet-connection structure and further almost exempt the occurrence of failure situation of rivet-connection and completely improve the shortcomings of strength weakening and rivet-connection failure caused by the inclination of the rivet which is easily happened during the rivet-connection of the plat head rivet in the prior technique.

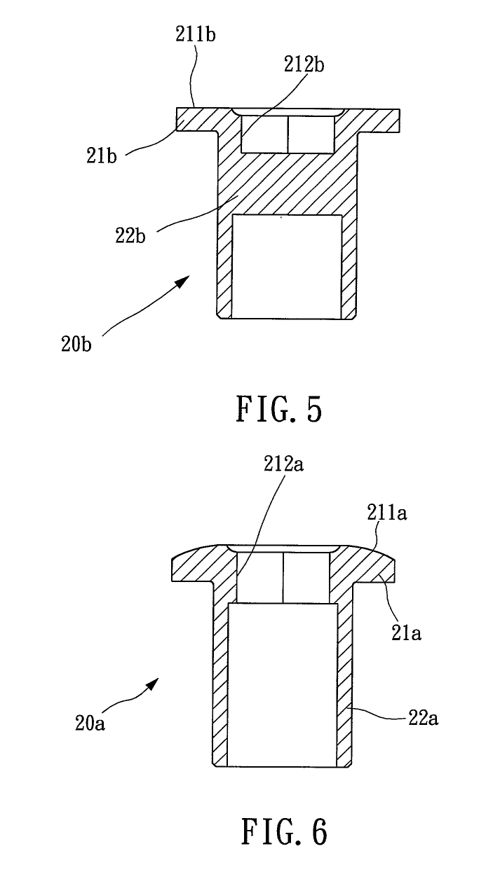

Please refer to FIG. 5, which is a cross-sectional view for the second preferable embodiment for the rivet 20a of the present invention. The rivet 20a is substantially same as the aforementioned embodiment and also has a head part 21a and a bolt part 22a. And, the head part 21a shows same convex arc curing surface 211a and also arranges with an internal hexagonal hole seat 212a. The difference between this embodiment shown in FIG. 5 and the aforementioned embodiment is that the internal hexagonal hole seat 212a is a penetration-through hole that penetrates through the rivet 20a and extends along the axis direction.

Please refer to FIG. 6, which is a cross-sectional view for a third preferable embodiment for the rivet 20b of the present invention. Substantially, the rivet 20b is same as the aforementioned embodiment and also has a head part 21b and a bolt part 22b. And, the head part 21b is similarly arranged with an internal hexagonal hole seat 212b. The difference between the embodiment shown in FIG. 6 and aforementioned embodiment is that: the upper surface on the head part 21b of the rivet 20b is a plane 211b.

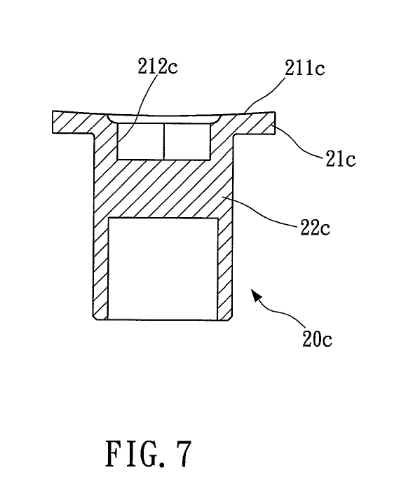

Please refer to FIG. 7, which is a cross-sectional view for a fourth preferable embodiment for the rivet 20c of the present invention. Substantially, the rivet 20c is same as the aforementioned embodiment and also has a head part 21c and a bolt part 22c. And, the head part 21c is similarly arranged with an internal hexagonal hole seat 212c. The difference between the embodiment shown in FIG. 7 and aforementioned embodiment is that: the upper surface on the head part 21c of the rivet 20c is a recessed arc curving surface 211c.

The present invention as aforementioned structure may really reach the expected function and effect. However, the above-mentioned descriptions for the embodiments for the present invention are to disclose the technical characteristics of the present invention, and are not to restrict the privilege of the present invention. For example, in the preferable embodiment of the present invention, although an internal hexagonal hole seat 212 is designed on the head part 21 of the rivet 20 to make its outline be resembled as an internal hexagonal screw, but the recessed hole seat of the head part may also be designed as a cross hole seat, a line hole seat, a square hole seat, a multi-angle hole seat, or hole seats of other shapes. Therefore, all the numbers' change and other equivalent interchange on the structure are still within the scopes of the present invention.

What is claimed is:

1. A combination structure of sprocket set and rivet, wherein the sprocket set is comprised of at least two sprockets, and several penetration-through holes are arranged at the corresponding positions between two sprockets;
the rivet includes a head part, which has a larger outer diameter, and a drum bolt part, which has a smaller outer diameter, and the two sprockets are connected and secured to one body, by accommodating the bolt part of the rivet into the penetration-through holes between two sprockets and then stamping and rivet-connecting them, wherein a recessed hole seat is also arranged on the head part of the rivet.

2. The combination structure of sprocket set and rivet as in claim 1, wherein the upper surface on the head of the rivet is a convex arc curving surface.

3. The combination structure of sprocket set and rivet as in claim 1, wherein the upper surface on the head of the rivet is a plane.

4. The combination structure of sprocket set and rivet as in claim 1, wherein the upper surface on the head of the rivet is a recessed arc curving surface.

5. The combination structure of sprocket set and rivet as in claim 1, wherein the internal hexagonal hole seat is a penetration-through rivet.

6. The combination structure of sprocket set and rivet as in claim 1, wherein the sprocket set is a large sprocket set in a bicycle.

7. The combination structure of sprocket set and rivet as in claim 1, wherein the recessed hole seat is an internal hexagonal hole seat.
